(19) United States
(12) Patent Application Publication
(10) Pub. No.: US 2020/0178681 A1
(43) Pub. Date: Jun. 11, 2020

(54) TOOTH-CLEANING DEVICE CAPABLE OF STORING OR BEING OPERATIVELY MOUNTED WITH INTERDENTAL BRUSH

(71) Applicant: Yi-Chung CHEN, Taipei City (TW)

(72) Inventor: Yi-Chung CHEN, Taipei City (TW)

(21) Appl. No.: 16/251,192

(22) Filed: Jan. 18, 2019

(30) Foreign Application Priority Data
Dec. 10, 2018 (TW) 107144368

(51) Int. Cl. A46B 15/00; A61C 15/04

(52) U.S. Cl. CPC A46B 15/0071; A61C 15/041; A61C 15/046; A46B 15/0073; A46B 2200/108; A61C 15/043

(57) ABSTRACT

A tooth-cleaning device capable of storing or being operatively mounted with an interdental brush includes a floss-pick unit and an interdental-brush unit. The floss-pick unit is provided with a floss-holding portion and a first assembly portion at two opposite ends respectively. The first assembly portion is in communication with an accommodating space in the floss-pick unit. The interdental-brush unit is provided with a second assembly portion and a third assembly portion at two opposite ends respectively. The second assembly portion is protrudingly provided with a bristle section. When the first and second assembly portions are mounted together, the bristle section extends through the first assembly portion to be stored in the accommodating space. Once the first and third assembly portions are mounted together, the bristle section is exposed outside the floss-pick unit. The floss-pick function and interdental-brush function of the tooth-cleaning device can thus be conveniently used.

### FIELD OF THE INVENTION

The present invention relates to a tooth-cleaning device and more particularly to a tooth-cleaning device configured as a floss pick and capable of storing the bristle section of, or being operatively mounted with, an interdental brush.

### BACKGROUND OF THE INVENTION

According to the American Academy of Periodontology (AAP), people with periodontitis are twice as likely to have coronary artery disease (CAD) as those without, the main reason being that bacteria associated with periodontitis may flow along the blood stream and form fatty plaques on, and thereby thicken, the walls of coronary arteries (which provide nutrients to the heart), resulting in thrombosis. This is why heart attacks, blood vessel clogging, and strokes have long been related to chronic inflammation caused by periodontal disease. Besides, adults with gingivitis (swollen and/or bleeding gums) perform worse in memory-related and other cognitive function tests than those with healthy gums and teeth. Oral health, therefore, is critical to the health of the entire body.

In addition to the foregoing health considerations, the maintenance of oral hygiene is essential to the quality of life. Healthy teeth, after all, contribute to self-confidence in socialization (e.g., having a conversation with others) and add to one's charm and charisma as they speak. Nowadays, most people keep the cleanliness of their oral cavity by tooth brushing and gargling. Toothbrushes are effective in removing dental plaques from the buccal side, the labial side, the lingual side, and the occlusal surface of teeth, but do poorly in removing interdental plaques. As a solution, tooth-cleaning tools that can pass through interdental gaps may be used to clean off plaques between the teeth.

Currently, two relatively common examples of tooth-cleaning tools for removing interdental plaques are floss picks and interdental brushes. A conventional floss pick generally includes a floss-holding portion and a handle. The floss-holding portion is U-shaped and has two corresponding ends that are fixedly connected to the two ends of a length of dental floss respectively. The handle is fixedly connected to the floss-holding portion in order to be gripped by a user. Such a conventional floss pick is typically used after meal by the user holding the handle of the conventional floss pick, placing the floss-holding portion into the mouth, and scraping off the food debris and/or dental plaques on and between the teeth with the floss on the floss-holding portion. As the floss on a conventional floss pick is tautly stretched, it is necessary to put the floss entirely into an interdental gap in order to remove the food debris and/or plaques in the gap. If the gap is too narrow to allow easy passage of the floss, it will be difficult for the conventional floss pick to remove the food debris and/or plaques in the portion of the gap that is adjacent to the gum. Should the user force the floss into such a narrow gap, the taut floss or the rigid floss-holding portion may hit the gum and cause the gum to bleed.

In light of the aforesaid drawbacks of the conventional floss picks during use, some may choose to clean their interdental gaps with interdental brushes instead. A conventional interdental brush is similar in size to a toothpick but has a tip with bristles. A user can insert the bristle portion of a conventional interdental brush into an interdental gap and use the bristles to pull out the food debris and/or plaques in the portion of the gap that is adjacent to the gum. During the process, the elastic bristles can also be moved back and forth to massage the gum. Thus, not only can the food debris and/or plaques in the portion of the interdental gap that is adjacent to the gum be completely removed while the gum is effectively protected from injury and bleeding, but also the gum can be massaged to promote blood circulation therein, both actions being helpful in maintaining oral health. As neither a floss pick nor an interdental brush can provide complete interdental gap cleaning and gum massage at the same time, those who place particular emphasis on oral health may have to use a floss pick and an interdental brush sequentially in order to have their interdental gaps completely cleaned and their gums massaged. However, the fact that both floss picks and interdental brushes are thin and tiny products is bound to trouble and inconvenience those who try to carry and store floss picks and interdental brushes separately for use.

To address the issue stated above, floss picks with bristles at the tail end (i.e., the end of the handle) were developed to serve as interdental brushes as well as floss picks. After using such products in person, however, the applicant of the present patent application found the following drawback. While cleaning teeth with such a floss pick, the fingers holding the floss pick tend to contact the bristles, which is unacceptable to those who pay close attention to hygiene. If the floss-pick function and the interdental-brush function are used alternately, the saliva and food debris on the bristles are very likely to stick to the fingers, making such products even more unacceptable in terms of hygiene and user perception. It is therefore an important subject for the tooth-cleaning device industry to solve the aforementioned problems and provide better user experience, and the very subject is addressed h the present invention.

### BRIEF SUMMARY OF THE INVENTION

In view of the disadvantages of the conventional floss picks and interdental brushes during use, the inventor of the present invention conducted extensive research and repeated experiments and finally succeeded in developing a tooth-cleaning device capable of storing or being operatively mounted with an interdental brush. The invention is intended to solve the foregoing problems of the prior art effectively so as to maximize user patron age.

One objective of the present invention is to provide a tooth-cleaning device that can store or be operatively mounted with an interdental brush. The tooth-cleaning device includes a floss-pick unit and an interdental-brush unit. The floss-pick unit is composed at least of a first main body, a floss-holding portion, and a length of dental floss, The first main body has one end connected to the floss-holding portion and the opposite end provided with a first assembly portion, The floss-holding portion is U-shaped and has two corresponding supporting arms, between which the floss is provided. The first assembly portion is hollow and is in communication with an accommodating space in the first main body. The interdental-brush unit is composed at least of a second main body, a second assembly portion, a third assembly portion, and a bristle section. The second assembly portion is provided at one end of the second main body while the third assembly portion is provided at the opposite end of the second main body. The bristle section is located at one end of the second assembly portion and is composed at least of a rod and a plurality of bristles. The rod has one end connected to the aforesaid end of the second assembly portion. The bristles are distributed at intervals along the periphery of the rod. To use the floss-pick function of the tooth-cleaning device, the bristle section is inserted through the first assembly portion into the accommodating space such that the second assembly portion and the first assembly portion are mounted to each other. To use the interdental-brush function of the tooth-cleaning device, the interdental-brush unit is pulled out, and the third assembly portion and the first assembly portion are mounted to each other to expose the bristle section.

### BRIEF DESCRIPTION OF THE SEVERAL VIEWS OF THE DRAWINGS

The objectives, technical features, and effects of the present invention can be better understood by referring to the following detailed description of some illustrative embodiments and the accompanying drawings, in which:

FIG. 1 is an exploded view of a tooth-cleaning device according to the present invention;

FIG. 2 shows the interdental-brush unit of the tooth-cleaning device in FIG. 1 in a stored state;

FIG. 3 shows the interdental-brush unit of the tooth-cleaning device in FIG. 1 in a ready-for-use state;

FIG. 4 is a partial view of the tooth-cleaning device according to another embodiment of the present invention; and

FIG. 5 is a partial view of the tooth-cleaning device according to yet another embodiment of the present invention.

### DETAILED DESCRIPTION OF THE INVENTION

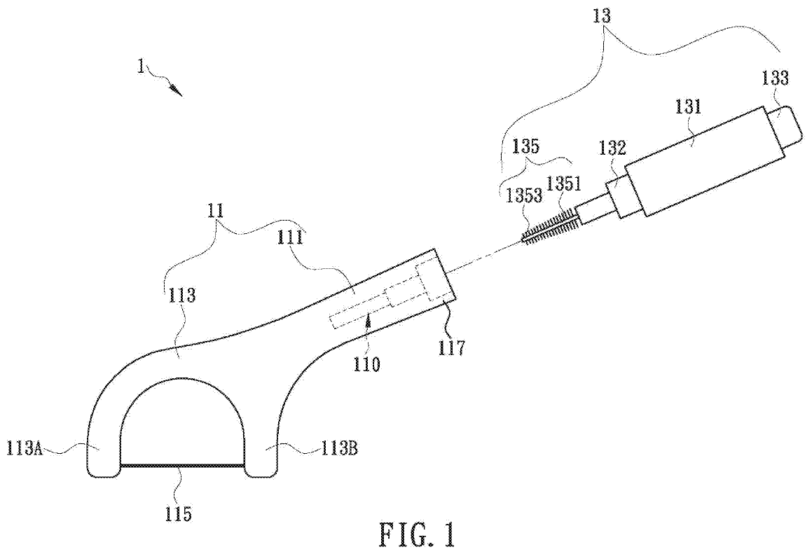

The present invention provides a tooth-cleaning device that can store or be operatively mounted with an interdental brush. Referring to FIG. 1, the tooth-cleaning device I includes a floss-pick unit 11 and an interdental-brush unit 13. In one embodiment, the floss-pick unit 11 is composed at least of a first main body 111, a floss-holding portion 113, and a length of dental floss 115. The first main body 111 is provided therein with accommodating space 110 and is connected to the floss-holding portion 113 at one end. The floss-holding portion 113 is U-shaped, is connected to the aforesaid end of the first main body 111 on a lateral side, and has two corresponding supporting arms 113A and 113B, between which the floss 115 is connected. In this embodiment, the floss 115 is twisted out of a plurality of strands of nylon fibers (by way of example but not limitation) so that a user can push the floss 115 into an interdental gap to perform such tooth-cleaning operations as removing the food debris and/or dental plaques between the teeth.

As shown in FIG. 1, the other end (hereinafter the second end) of the first main body 111 is provided with a first assembly portion 117. The first assembly portion 117 is hollow and has an opening in communication with the accommodating space 110. In this embodiment, the first main body 111, the first assembly portion 117, and the floss-holding portion 113 are integrally formed of a first plastic material (e.g., polypropylene (PP), an acrylonitrile butadiene styrene (ABS) copolymer, or a high-impact polystyrene (HIPS)) by injection molding. In other embodiments of the present invention, the first assembly portion 117 may be a separate component (e.g., a washer) placed into the opening at the second end of the first main body 111 and secured in place by adhesive bonding, hot-melting, or the like, and the material of this first assembly portion may be different from that of the first main body 111, with a view to meeting the practical needs of various products.

With continued reference to FIG. 1, the interdental-brush unit 13 is composed at least of a second main body 131, a second assembly portion 132, a third assembly portion 133, and a bristle section 135. The second assembly portion 132 is provided at one end (hereinafter the first end) of the second main body 131, and the bristle section 135 is located at the end of the second assembly portion 132 that faces away from the second main body 131. The third assembly portion 133 is provided at the other end of the second main body 131. In this embodiment, and by way of example only, the second main body 131, the second assembly portion 132, and the third assembly portion 133 are integrally formed of the first plastic material (e.g., PP, ABS, or HIPS) by injection molding. As an alternative, the second assembly portion 132 and the third assembly portion 133 may each be a separate component. For example, the second assembly portion 132 may be a separate block fixed on the second main body 131 by mechanical engagement, adhesive bonding, hot-melting, or the like, or be a washer fixedly mounted around a post at the first end of the second main body 131.

Referring again to FIG. 1, the bristle section 135 is composed at least of a rod 1351 and a plurality of bristles 1353, The rod 1351 has one end connected to the aforesaid end of the second assembly portion 132. The bristles 1353 are distributed at intervals along the periphery of the rod 1351 so that, once the bristle section 135 is inserted into an interdental gap, the bristles 1353 can easily pull out the food debris and/or dental plaques in the portion of the gap that is adjacent to the gum, and can also be moved in a reciprocating manner to massage the gum. In this embodiment, the rod 1351 is integrally formed of the first plastic material (e.g., PP, ABS, or HIPS) on the second assembly portion 132 by injection molding, and the bristles 1353 are integrally formed of a second plastic material (e.g., a thermoplastic elastomer (TPE) or other medical-grade artificial rubber) on the periphery of the rod 1351 by injection molding, wherein the second plastic material has a lower hardness .e., is more pliable) than the first plastic material to effectively protect the user's teeth, gums, and interdental papillae from scratching, puncturing, and abrasion attributable to a rigid structure. In other embodiments of the present invention, the bristle section 135 may be a separate component and be made of a metal wire (as the rod 1351) and nylon (as the bristles 1353) rather than the plastic materials disclosed herein.

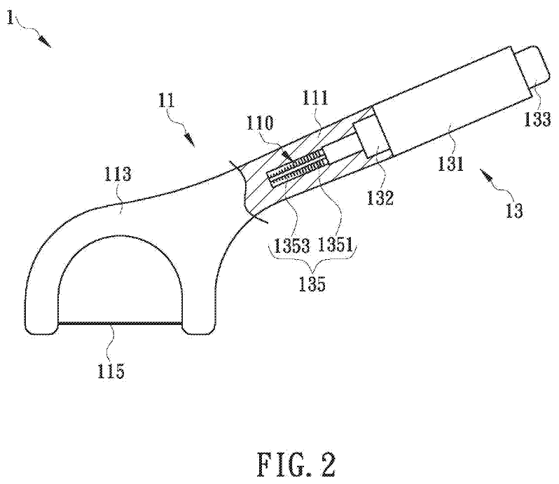

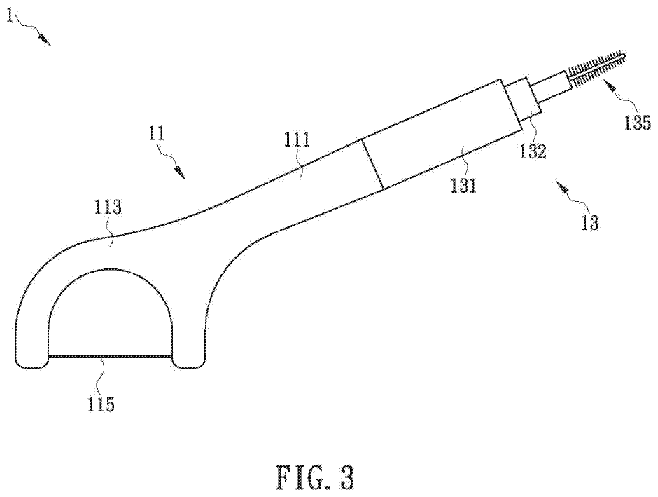

The overall structure of the present invention is such that, when the floss-pick function is desired, the user can mount the second assembly portion 132 and the first assembly portion 117 to each other, with the bristle section 135 passing through the first assembly portion 117 into the accommodating space 110, thereby coupling the interdental-brush unit 13 and the floss-pick unit 11 together, storing the bristle section 135 in the first main body 111 (see FIG. 2), and forming a handle out of the first main body 111 and the second main body 131 so that the user can grip the handle and insert the floss-holding portion 113 into the mouth to perform the desired tooth-cleaning operation. When it is subsequently desired to use the interdental-brush function alone, the user can hold the second main body 131 and pull out the interdental-brush unit 13. The interdental-brush unit 13 can be used either independently or by mounting the third assembly portion 133 and the first assembly portion 117 to each other to expose the bristle section 135 (see FIG. 3) and to form a handle out of the first main body iii and the second main body 131 so that the user can grip the handle and insert the bristle section 135 into the mouth to perform the desired tooth-cleaning operation.

It can be known from the above that the bristle section 135 is hidden in the first main body 111 (see FIG., 2), and thus kept from contact with the user's fingers, while the floss-pick function is used. This prevents not only any dirt on the fingers from contaminating the bristle section 135, but also the saliva or food debris on the bristle section 135 from sticking to the fingers. When the interdental-brush function is used, the second main body 131 can be assembled to the first main body 111 to form a relatively long handle, making it easier for the user to hold and operate the tooth-cleaning device 1, thereby eliminating the need for the manufacturer to increase the length of the second main body 131 to facilitate operation. This allows the tooth-cleaning device 1 of the present invention to be downsized as much as possible while maintaining the ease of use.

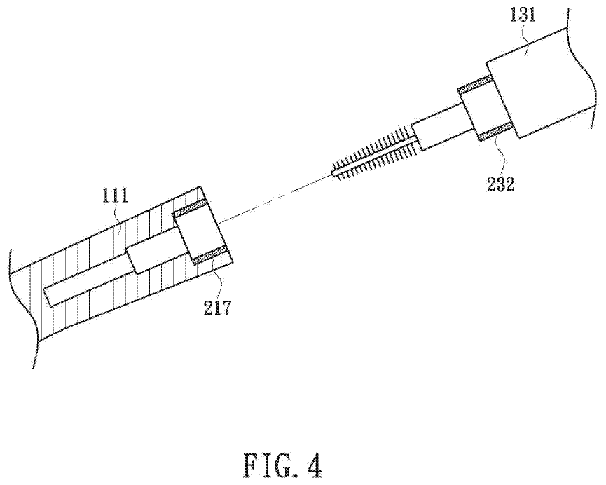

The floss-pick unit 11 and the interdental-brush unit 13 of the present invention can be mounted to each other through a press fit or threaded connection, as explained in more detail below. The carry out the “press fit” mounting method, referring to FIG. 1, the diameter of the inner periphery of the first assembly portion 117 is rendered slightly smaller than the diameter of the second assembly portion 132, or the diameter of only a portion of the inner periphery of the first assembly portion 117 is rendered slightly smaller than the diameter of the second assembly portion 132 (e.g., by providing the inner periphery of the first assembly portion 117 or of the second assembly portion 132 with protruding dots or protruding lines) so that, thanks to the moderate deformability of the material of the first assembly portion 117 or the second assembly portion 132, the second assembly portion 132 can be securely positioned in the first assembly portion 117. In order to mount the floss-pick unit 11 and the interdental-brush unit 13 even more tightly to each other, the first assembly portion or the second assembly portion in another embodiment of the present invention is an elastic washer. In FIG. 4 for example, the first assembly portion 217 is a washer placed in the opening at the second end of the first main body 111, the second assembly portion 232 is a washer mounted around the post at the first end of the second main body 131, and the properties of the washers allow the first assembly portion 217 and the second assembly portion 232 to couple with each other in a particularly tight manner, although it is feasible for only one of the first assembly portion 217 and the second assembly portion 232 to be a washer. By the same token, the third assembly portion 133 of the present invention may have the same structural features as the second assembly portions 132 and 232.

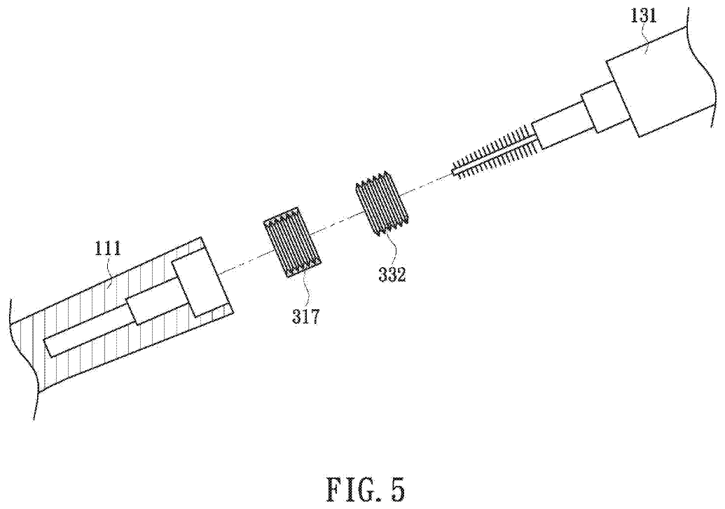

To carry out the “threaded connection” mounting method, the inner periphery of the first assembly portion has an internal thread, and the (outer) periphery of the second assembly portion has an external thread, so by rotating the floss-pick unit 11 and the interdental-brush unit 13 with respect to each other, the first assembly portion 317 and the second assembly portion 332 can be threadedly connected. In one embodiment of the present invention as shown in FIG. 5, the first assembly portion 317 and the second assembly portion 332 are separate threaded components, wherein the first assembly portion 317 is placed in the opening at the second end of the first main body 111 and the second assembly portion 332 is mounted around the post at the first end of the second main body 131. The third assembly portion of the present invention may follow suit and have the same structural feature as the second assembly portion 332. In another embodiment of the present invention, though, the configuration of the third assembly portion is different from that of the second assembly portion.

While the invention herein disclosed has been described by means of specific embodiments, numerous modifications and variations could be made thereto by those skilled in the art without departing from the scope of the invention set forth in the claims.

What is claimed is:

1. A tooth-cleaning device capable of storing or being operatively mounted with an interdental brush, comprising:
a floss-pick unit composed at least of a first main body, a floss-holding portion, and a length of dental floss, wherein the first main body is provided therein with an accommodating space, the first main body has an end connected to the floss-holding portion, the floss-holding portion is U-shaped and has two corresponding supporting arms, the dental floss is provided between the supporting arms, the first main body has an opposite end provided with a first assembly portion, and the first assembly portion is hollow and is in communication with the accommodating space; and
an interdental-brush unit composed at least of a second main body, a second assembly portion, a third assembly portion, and a bristle section, wherein the second assembly portion is provided at an end of the second main body, the third assembly portion is provided at an opposite end of the second main body, the bristle section is located at an end of the second assembly portion and is composed at least of a rod and a plurality of bristles, the rod has an end connected to the end of the second assembly portion, the bristles are distributed at intervals along a periphery of the rod, the bristle section extends through the first assembly portion into the accommodating space when the second assembly portion and the first assembly portion are mounted to each other, and the bristle section is exposed from the floss-pick unit when the third assembly portion and the first assembly portion are mounted to each other.

2. The tooth-cleaning device of claim 1, wherein a diameter of an entire or partial inner periphery of the first assembly portion is slightly smaller than a diameter of a periphery of the second assembly portion so that the first assembly portion and the to second assembly portion are able to be mounted to each other through a press fit.

3. The tooth-cleaning device of claim 2, wherein the diameter of the entire or partial inner periphery of the first assembly portion is slightly smaller than a diameter of a periphery of the third assembly portion so that the first assembly portion and the third assembly portion are able to be mounted to each other through a press fit.

4. The tooth-cleaning device of claim 1, wherein the first assembly portion has an inner periphery provided with an internal thread, and the second assembly portion has a periphery provided with an external thread so that the first assembly portion and the second assembly portion are able to be mounted to each other through threaded connection.

5. The tooth-cleaning device of claim 4, wherein the third assembly portion has a periphery provided with an external thread so that the first assembly portion and the third assembly portion are able to be mounted to each other through threaded connection.

6. The tooth-cleaning device of claims 1, wherein the second main body, the second assembly portion, the third assembly portion, and the rod are integrally formed of a first plastic material by injection molding.

7. The tooth-cleaning device of claims 2, wherein the second main body, the second assembly portion, the third assembly portion, and the rod are integrally formed of a first plastic material by injection molding.

8. The tooth-cleaning device of claims 3, wherein the second main body, the second assembly portion, the third assembly portion, and the rod are integrally formed of a first plastic material by injection molding.

9. The tooth-cleaning device of claims 4, wherein the second main body, the second assembly portion, the third assembly portion, and the rod are integrally formed of a first plastic material by injection molding.

10. The tooth-cleaning device of claims 5, wherein the second main body, the second assembly portion, the third assembly portion, and the rod are integrally formed of a first plastic material by injection molding.

11. The tooth-cleaning device of claim 6, wherein the bristles are integrally formed of a second plastic material on the periphery of the rod by injection molding, and the second plastic material has a lower hardness than the first plastic material.

12. The tooth-cleaning device of claim 7, wherein the bristles are integrally formed of a second plastic material on the periphery of the rod by injection molding, and the second plastic material has a lower hardness than the first plastic material.

13. The tooth-cleaning device of claim 8, wherein the bristles are integrally formed of a second plastic material on the periphery of the rod by injection molding, and the second plastic material has a lower hardness than the first plastic material.

14. The tooth-cleaning device of claim 9, wherein the bristles are integrally formed of a second plastic material on the periphery of the rod by injection molding, and the second plastic material has a lower hardness than the first plastic material.

15. The tooth-cleaning device of claim 10, wherein the bristles are integrally formed of a second plastic material on the periphery of the rod by injection molding, and the second plastic material has a lower hardness than the first plastic material.

16. The tooth-cleaning device of claim 6, wherein the first main body, the first assembly portion, and the floss-holding portion are integrally formed of the first plastic material by injection molding.

17. The tooth-cleaning device of claim 7, wherein the first main body, the first assembly portion, and the floss-holding portion are integrally formed of the first plastic material by injection molding.

18. The tooth-cleaning device of claim 8, wherein the first main body, the first assembly portion, and the floss-holding portion are integrally formed of the first plastic material by injection molding.

19. The tooth-cleaning device of claim 9, wherein the first main body, the first assembly portion, and the floss-holding portion are integrally formed of the first plastic material by injection molding.

20. The tooth-cleaning device of claim 10, wherein the first main body, the first assembly portion, and the floss-holding portion are integrally formed of the first plastic material by injection molding.
